(19) United States
(12) Patent Application Publication
(10) Pub. No.: US 2011/0005334 A1
(43) Pub. Date: Jan. 13, 2011

(54) TUNABLE FLUID FLOW CONTROL SYSTEM

(75) Inventors: Joel Meier Haynes, Schenectady, NY (US); Ciro Cerretelli, Toscolano Maderno (IT)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/499,152

(22) Filed: Jul. 8, 2009

(51) Int. Cl. G01F 1/20

(52) U.S. Cl. 73/861.19

(57) ABSTRACT

A tunable fluid flow control system includes a fluidic oscillator having a movable boundary wall. A pressurized gas source is coupled to the movable boundary wall and configured to supply a stream of pressurized gas to the movable boundary wall to actuate the boundary wall. The boundary wall is actuatable to vary a cavity volume in the fluidic oscillator so as to control frequency of flow of a pulsating fluid generated by the fluidic oscillator. A portion of a fluid is bypassed the fluidic oscillator so as to control amplitude of flow of a pulsating fluid generated by the fluidic oscillator.

### BACKGROUND

The invention relates generally to tunable fluid flow control system, and more particularly to a tunable fluidic oscillator for controlling dynamic pressure variations in a combustor, drag of a fluid boundary layer, or combinations thereof.

In one application involving combustion, lean premixed combustion (LPC) is currently one of the most promising concepts for substantial reduction of emissions while maintaining high efficiency for gas turbine combustors. This mode of combustion is operated with excess air to reduce flame temperatures in combustors to acceptable levels typically less than 1800 Kelvin. At these flame temperatures, the production of thermal NOX (oxides of nitrogen) is virtually eliminated; and the production of prompt NOX is negligible. This intrinsic benefit can be offset by several potential disadvantages. LPC systems can have problems with flame stability, noise, and can exhibit system dynamic responses (combustion instabilities).

Combustion dynamics (or instability) is well known problem encountered by the lean premixed combustion systems leading to operational restrictions and even to potential hardware downtime. Fluctuations in fuel-air-ratio may play a vital role in driving the combustion dynamics. Conventional approaches to suppress the dynamics include using mechanically actuated systems for generating fuel flow fluctuations to drive stability. However, the mechanically actuated systems have the drawbacks that the characteristic response frequency and life of mechanically actuated systems are limited.

In another application, centrifugal compressors, for example are employed to increase the pressure of a gaseous fluid, such as air for pumping, or for providing fluid to a downstream device such as a combustor or a turbine. One of the drawbacks arising in the use of centrifugal compressors for applications where the compression load varies over a wide range is flow de-stabilization (i.e., flow separation) through the compressor. Conventional approaches to suppress the flow de-stabilization include using mechanically actuated systems to generate a pulsating gas stream and stabilize the flow through the compressor. However, the mechanically actuated systems have the drawbacks that the characteristic response frequency and life of mechanically actuated systems are limited.

Accordingly, there is a need for tunable fluid flow control system.

### BRIEF DESCRIPTION

In accordance with one exemplary embodiment of the present invention, a tunable fluid flow control system is disclosed. The control system includes a fluidic oscillator having a movable boundary wall. A pressurized gas source is coupled to the movable boundary wall and configured to supply a stream of pressurized gas to the movable boundary wall to actuate the boundary wall. The boundary wall is actuatable to vary a cavity volume in the fluidic oscillator so as to control frequency of flow of a pulsating fluid through the fluidic oscillator. A portion of a fluid is bypassed the fluidic oscillator so as to control amplitude of flow of a pulsating fluid generated by the fluidic oscillator.

In accordance with another exemplary embodiment of the present invention, a tunable fuel flow control system for controlling combustion in at least one combustor is disclosed.

In accordance with another exemplary embodiment of the present invention, a tunable fluid flow control system for controlling drag of at least one fluid boundary layer is disclosed.

In accordance with another exemplary embodiment of the present invention, an open-loop fluid flow control system is disclosed. The control system includes a sensor configured to detect dynamic pressure variations of at least one combustor, drag of at least one fluid boundary layer, or combinations thereof. A pressurized gas source is coupled to a movable boundary wall of a fluidic oscillator and configured to supply a stream of pressurized gas to the movable boundary wall to actuate the boundary wall. A portion of a fluid is bypassed the fluidic oscillator so as to control amplitude of flow of a pulsating fluid generated by the fluidic oscillator based on an amplitude set value. The boundary wall is actuatable to vary a cavity volume in the fluidic oscillator so as to control frequency of flow of the pulsating fluid generated by the fluidic oscillator based on a frequency set value. Frequency, amplitude, or combinations thereof of flow of the pulsating fluid is controlled to control dynamic pressure variations of the at least one combustor, drag of the at least one fluid boundary layer, or combinations thereof.

In accordance with another exemplary embodiment of the present invention, a closed-loop fluid flow control system is disclosed. A controller is coupled to the sensor, and the fluidic oscillator. The controller is configured to control flow of a portion of a fluid bypassing the fluidic oscillator in response to a sensor output so as to control amplitude of flow of a pulsating fluid generated by the fluidic oscillator. The controller is also configured to control actuation of the boundary wall in response to the sensor output to vary a cavity volume in the fluidic oscillator so as to control frequency of flow of the pulsating fluid generated by the fluidic oscillator.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a tunable fluid flow control system having a fluidic oscillator with a plurality of pistons and cylinders in accordance with an exemplary embodiment of the present invention;

FIG. 2 is a diagrammatical representation of a tunable fluid flow control system having a fluidic oscillator with a diaphragm in accordance with an exemplary embodiment of the present invention;

FIG. 3 is a diagrammatical representation of a tunable fluid flow control system having a fluidic oscillator with at least one bellow in accordance with an exemplary embodiment of the present invention;

FIG. 4 is a diagrammatical representation of a tunable fuel flow control system for combustion control in a combustor in accordance with an exemplary embodiment of the present invention;

FIG. 5 is a diagrammatical representation of a tunable fluid flow control system for boundary layer separation control in accordance with an exemplary embodiment of the present invention;

FIG. 6 is a diagrammatical representation of an open-loop tunable fluid flow control system in accordance with an exemplary embodiment of the present invention; and

FIG. 7 is a diagrammatical representation of a closed-loop tunable fluid flow control system in accordance with an exemplary embodiment of the present invention.

### DETAILED DESCRIPTION

As discussed in detail below, certain embodiments of the present invention discloses a tunable fluid flow control system having a fluidic oscillator. The fluidic oscillator includes a movable boundary wall. A pressurized gas source is coupled to the movable boundary wall and configured to supply a stream of pressurized gas to the movable boundary wall to actuate the boundary wall. The boundary wall is actuatable to vary a cavity volume in the fluidic oscillator so as to control frequency of flow of a pulsating fluid through the fluidic oscillator. A portion of a fluid is bypassed the fluidic oscillator so as to control amplitude of flow of a pulsating fluid generated by the fluidic oscillator. In accordance with some embodiments of the present invention, a tunable fluidic oscillator supplies a pulsating fluid stream to a target of interest at a frequency, amplitude, or combinations thereof chosen by an operator using the control system. In accordance with certain other embodiments of the present invention, the tunable fluid flow control system may be operated as a closed-loop system. In one embodiment, such tunable fluid flow control system may be particularly useful for providing a pulsating fuel flow stream so as to stabilize combustion within at least one combustor. In another embodiment, the exemplary tunable fluid flow control system may be used to provide a pulsating fluid stream to control at least one fluid boundary layer so as to reduce drag of the at least one fluid boundary layer.

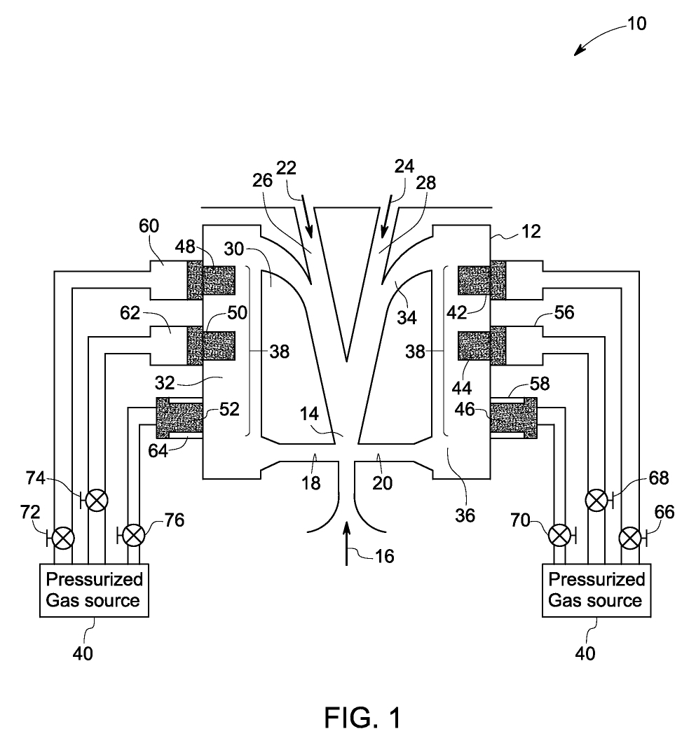

Turning now to FIG. 1, an exemplary tunable fluid flow control system 10 is disclosed. The control system 10 includes a fluidic oscillator 12 configured to control flow of a fluid stream to a target of interest. The fluidic oscillator 12 includes a first throat 14, and a first input port 16, a first control port 18 and a second control port 20, each connected to the first throat 14. The fluidic oscillator 12 also includes a first output port 22 and a second output port 24 coupled to the first throat 14 via a first output channel 26 and a second output channel 28 respectively. The fluidic oscillator 12 further includes a first feedback line 30 coupling the first output channel 26 to a first feedback chamber 32 and a second feedback line 34 coupling the second output channel 28 to a second feedback chamber 36.

The fluidic oscillator 12 taken as a matter of illustration is constituted by a fluidic flip-flop diverter mechanism, where the control fluid is blown from the input port 16 onto a wedge formed between the two bifurcating output channels 26 and 28 that open to the environment through the output ports 22 and 24 respectively. Owing to the wall attachment phenomenon, commonly known as coanda effect, the flow of the control fluid diverts to either one of the two output ports 22 and 24. By applying the proper pressure to the control ports 18 and 20, it is possible to divert the flow of the control fluid to the other output port, and vice versa. Since the fluidic oscillators are symmetrical, on steady state, the change in direction of the control fluid flow through the two output ports of each fluidic oscillator is sustained at some frequency. Through proper design, the fluidic oscillator 12 may be made to emit alternating pulses of flow from each of the output ports at a certain desired frequency, amplitude, or combinations thereof. Although one fluidic oscillator is illustrated, the control system 10 may include an array of such fluidic oscillators.

The fluidic oscillator 12 includes a movable boundary wall 38, and a pressurized gas source 40 coupled to the movable boundary wall 38. In the illustrated embodiment, the movable boundary wall 38 includes a plurality of pistons 42, 44, 46, 48, 50, 52 actuatably disposed in cylinders 54, 56, 58, 60, 62, 64 respectively. The cylinders 54, 56, 58 are coupled to the pressurized gas source 40 via a plurality of corresponding frequency control devices, for example frequency control valves 66, 68, 70. Similarly, the cylinders 60, 62, 64 are coupled to the pressurized gas source 40 via a plurality of corresponding frequency control valves 72, 74, 76. In some embodiments, each cylinder may be coupled to a separate pressurized gas source 40. The pressurized gas source 40 is configured to supply a stream of pressurized gas to the cylinders 54, 56, 58, 60, 62, 64. The frequency control valves 66, 68, 70 are configured to control flow of gas fed to the corresponding cylinders 54, 56, 58 and individually control actuation of corresponding pistons 42, 44, 46. Similarly the valves 72, 74, 76 are configured to control flow of gas fed to the corresponding cylinders 60, 62, 64 and individually control actuation of corresponding pistons 48, 50, 52.

When the pressurized gas is fed from the source 40 to the cylinders 54, 56, 58, 60, 62, 64, the pistons 42, 44, 46, 48, 50, 52 are moved from the corresponding cylinders 54, 56, 58, 60, 62, 64 towards the chambers 32, 36 so as to reduce a cavity volume of the chambers 32, 36. When pressurized gas is not fed from the source 40 to the cylinders 54, 56, 58, 60, 62, 64, the pistons 42, 44, 46, 48, 50, 52 are moved from the chambers 32, 36 into the corresponding cylinders 54, 56, 58, 60, 62, 64 so as to increase a cavity volume of the chambers 32, 36. In other words, the boundary wall 38 is actuatable to vary a cavity volume of the chambers 32, 36 so as to control frequency of flow of a pulsating fluid fed through the fluidic oscillator 12. Such variation of a cavity volume of the fluidic oscillator 12 facilitates to control frequency of flow of fluid fed through the fluidic oscillator 12. Such variation of cavity volume of the fluidic oscillator 12 may be useful for providing a pulsed fuel flow for stabilization of combustion in a combustor, and also for reducing separation of a fluid boundary layer.

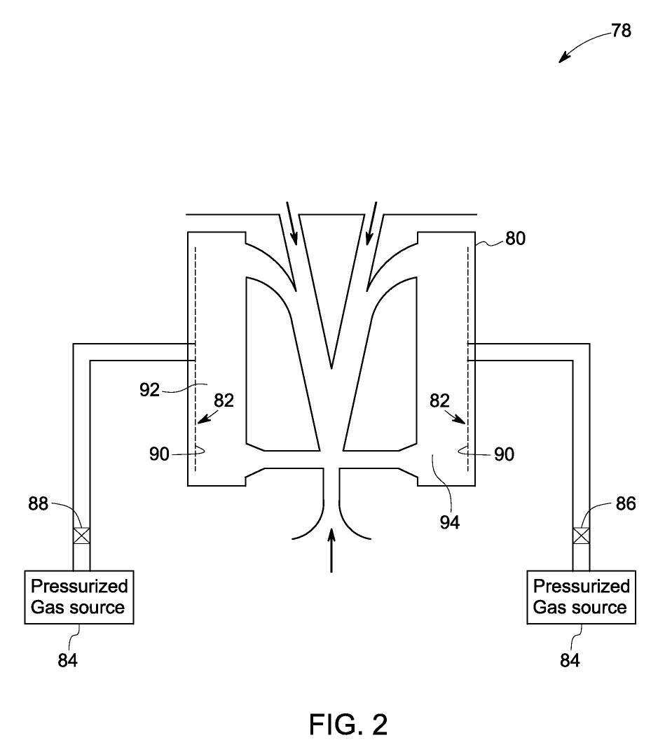

Turning now to FIG. 2, an exemplary tunable fluid flow control system 78 is disclosed. The control system 10 includes a fluidic oscillator 80 configured to control flow of a fluid stream to a target of interest. The configuration of the fluidic oscillator 78 is more or less similar to the embodiment discussed above with reference to FIG. 1. In the illustrated embodiment, the fluidic oscillator 80 includes a movable boundary wall 82, and a pressurized gas source 84 coupled to the movable boundary wall 82 via a plurality of frequency control devices, for example gas pressure regulators 86, 88. The movable boundary wall 82 includes at least one diaphragm 90. The diaphragm 90 is actuatable or deflectable in response to the supply of pressurized gas from the source 84.

When the pressurized gas is fed from the source 84 to the diaphragm 90, the diaphragm 90 is deflected into chambers 92, 94 so as to reduce a cavity volume of the chambers 92, 94. When pressurized gas is not fed from the source 84 to the diaphragm 90, the diaphragm 90 is not deflected into the chambers 92, 94 so as to increase a cavity volume of the chambers 92, 94. In other words, the boundary wall 82 is actuatable to vary a cavity volume of the chambers 92, 94 so as to control the frequency of flow of a pulsating fluid fed through the fluidic oscillator 80.

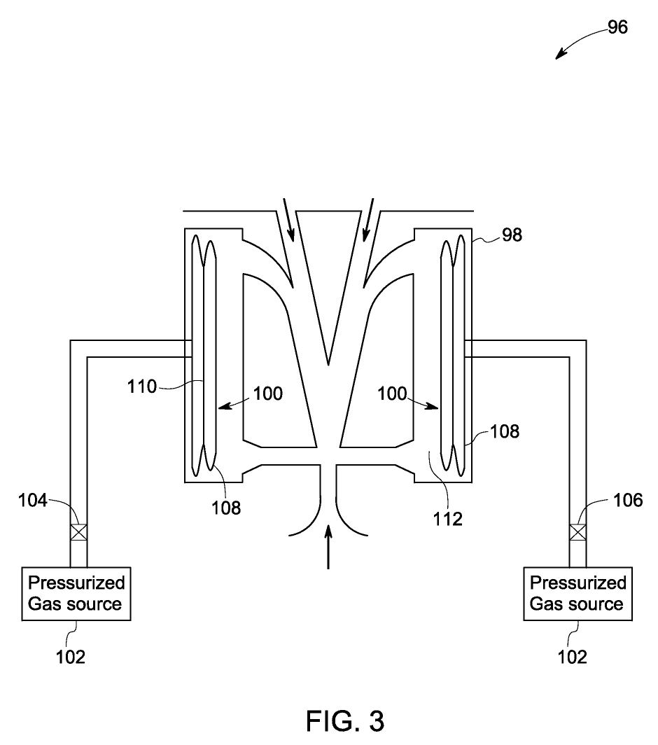

Referring to FIG. 3, an exemplary tunable fluid flow control system 96 is disclosed. The control system 96 includes a fluidic oscillator 98 configured to control flow of a fluid stream to a target of interest. The configuration of the fluidic oscillator 98 is more or less similar to the embodiment discussed above with reference to FIGS. 1 and 2. In the illustrated embodiment, the fluidic oscillator 98 includes a movable boundary wall 100, and a pressurized gas source 102 coupled to the movable boundary wall 100 via a plurality of frequency control devices, for example gas pressure regulators 104, 106. The movable boundary wall 100 includes at least one bellow 108. The bellow 108 is actuatable (expandable and contractable) in response to the supply of a stream of pressurized gas from the source 102.

When the pressurized gas is fed from the source 102 to the bellow 108, the bellow 108 is inflated into chambers 110, 112 so as to reduce a cavity volume of the chambers 110, 112. When pressurized gas is not fed from the source 102 to the bellow 108, the bellow 108 is deflated so as to increase a cavity volume of the chambers 110, 112. In other words, the boundary wall 100 is actuatable to vary a cavity volume of the chambers 110, 112 so as to control frequency of flow of a pulsating fluid fed through the fluidic oscillator 98.

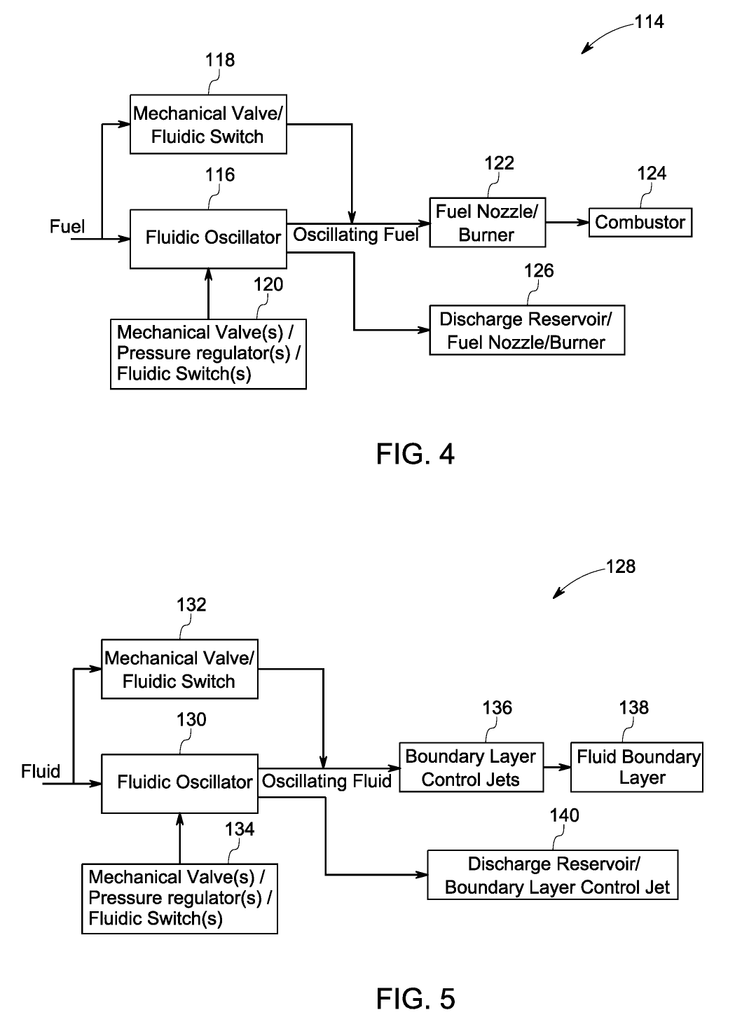

Referring to FIG. 4, an exemplary tunable fluid flow control system 114 is disclosed. As discussed previously, the control system 114 includes a fluidic oscillator 116 configured to control flow of a fluid stream to a target of interest. The In the illustrated embodiment, a portion of a fuel stream may be bypassed through an amplitude control device 118 configured to control amplitude of the pulsating fuel stream generated from the fluidic oscillator 116. In one embodiment, the amplitude control device 118 is a mechanical valve. In another embodiment, the amplitude control device 118 is a fluidic switch. Similar to the previous embodiments, a frequency control device 120 is configured to control flow of gas fed to the fluidic oscillator 116. The frequency control device 120 may include one or more mechanical valves or pressure regulators or fluidic switches. The fluidic oscillator 116 is configured to feed a pulsating fuel stream to a fuel nozzle or burner 122 and, thereby control combustion in a combustor 124. As discussed above, a boundary wall of the fluidic oscillator 116 is actuatable to vary a cavity volume of the fluidic oscillator 116 so as to control frequency, amplitude, or combinations thereof of flow of a pulsating fuel stream fed through the fluidic oscillator 116. As noted above, the fluidic oscillator generates more than one pulsating fuel stream. One of the pulsating fuel stream from the fluidic oscillator 116 may be fed to a discharge reservoir or another fuel nozzle/burner represented by the reference numeral 126.

Combustion dynamics (or instability) is well known problem encountered by the lean premixed combustion systems leading to operational restrictions and even to potential hardware downtime. Fluctuations in fuel-air-ratio may play a vital role in driving the combustion dynamics. In accordance with exemplary embodiments of the present invention, variation of a cavity volume of the fluidic oscillator 116 facilitates to control frequency, amplitude, or combinations thereof of flow of fuel stream fed through the fluidic oscillator 116 to the combustor 124 and, thereby control combustion dynamics within the combustor 124.

In certain embodiments, the fuel stream may include hydrocarbons, natural gas, or high hydrogen gas, or hydrogen, or biogas, or carbon monoxide, or syngas along with predetermined amount of diluents. In some embodiments, the fuel stream may include liquid fuels. In one embodiment, the combustor 124 includes a can combustor. In an alternate embodiment, the combustor 124 includes a can-annular combustor or a purely annular combustor.

Referring to FIG. 5, an exemplary tunable fluid flow control system 128 is disclosed. As discussed previously, the control system 128 includes a fluidic oscillator 130 configured to control flow of a fluid stream to a target of interest. In the illustrated embodiment, a portion of a fluid stream may be bypassed through an amplitude control device 132 configured to control amplitude of the pulsating fluid stream generated from the fluidic oscillator 130. The amplitude control device 132 may be a mechanical valve or a fluidic switch. A frequency control device 134 is configured to control flow of gas fed to the fluidic oscillator 130. The control device 134 may include one or more mechanical valves or pressure regulators or fluidic switches.

It has been observed in devices such as for example, centrifugal compressors that, when the actual volumetric flow rate through the centrifugal compressor is below the stall point, the fluid flow through the compressor becomes unstable from the stalling behavior of a diffuser or an impeller. As a result, the pumping capability of the compressor is limited. In accordance with aspects of the present invention, the use of pulsed blowing of fluid control jets 136 via the fluidic oscillator 130 into a boundary layer 138 enhances the efficiency of the flow control in the compressor.

In some embodiments, a pulsed stream of air is blown to the fluid boundary layer 138 upstream of a separation point to energize a weak flow and suppress boundary layer separation. In a jet of control fluid that typically exits from an exemplary fluidic oscillator to a surrounding medium of another fluid, the sudden increase of the mass-flow leads to the formation of well-defined vortices that dominate the boundary between the control fluid and the surrounding main fluid. Because these vortices help redistribute momentum over a large distance, the rate of turbulent mixing between the control fluid and the main fluid is closely linked to the dynamics of these vortices. One way to manipulate the dynamics of the vortices is to modulate the instantaneous mass-flux of the jet. One of the pulsating fluid stream from the fluidic oscillator 130 may be fed to a discharge reservoir or another fluid control jet represented by the reference numeral 140.

The fluidic oscillator 130 may also be disposed in other arrangements requiring boundary layer separation control in accordance with aspects of the present invention. As discussed above, the boundary wall of the fluidic oscillator 130 is actuatable to vary a cavity volume of the fluidic oscillator 130 so as to control frequency, amplitude, or combinations thereof of flow of pulsed control jets fed through the fluidic oscillator 130 to the fluid boundary layer 138. Even though the control system 128 is discussed herein with reference to combustion control and boundary layer separation control, the fluidic oscillators could be disposed in other arrangements as well without departing from the spirit of this invention.

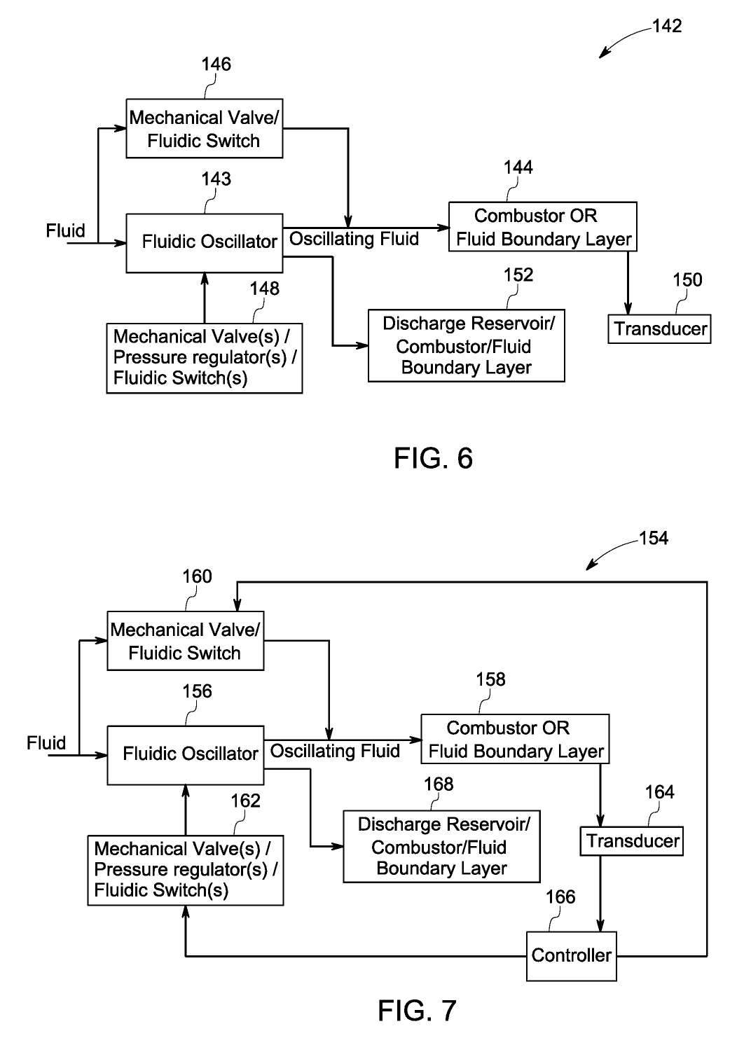

Referring to FIG. 6, a tunable fluid flow control system 142 is disclosed. In the illustrated embodiment, the system 142 is an open-loop system. The control system 142 includes one or more fluidic oscillators 143 configured to provide a pulsed fuel stream to a combustor or pulsed control jets to a fluid boundary layer. The combustor or the fluid boundary layer is represented by the reference numeral 144. In the illustrated embodiment, a portion of a fluid stream may be bypassed through an amplitude control device 146 configured to control amplitude of the pulsating fluid stream generated from the fluidic oscillator 142. The amplitude control device 146 may be a mechanical valve or a fluidic switch. A frequency control device 148 is configured to control flow of gas fed to the fluidic oscillator 130. The frequency control device 148 may include one or more mechanical valves or pressure regulators or fluidic switches. The system 142 further includes at least one transducer (sensor) 150 configured to detect dynamic pressure variations in the combustor or drag of the fluid boundary layer.

A boundary wall of the fluidic oscillator 143 is actuatable to vary a cavity volume so as to control frequency, amplitude, or combinations thereof of flow of a pulsating fluid fed through the fluidic oscillator 143. The frequency of flow of a pulsating fluid may be controlled based on a frequency set value set by the operator. The amplitude of flow of a pulsating fluid may be controlled based on an amplitude set value set by the operator. In certain embodiments, the frequency set value and the amplitude set value may be reset based on the transducer output. It should be noted herein that actuation of the boundary wall is controlled based on flow of the gas stream fed to the boundary wall. In an open-loop system, the flow of the gas stream fed to the boundary wall may be controlled manually. Such variation of a cavity volume of the fluidic oscillator 143 facilitates to control frequency, amplitude of flow of fluid fed through the fluidic oscillator 143. The variation of cavity volume of the fluidic oscillator 143 is used for providing a pulsed fuel flow for stabilization of combustion in a combustor, or for reducing separation of a fluid boundary layer. One of the pulsating fluid stream from the fluidic oscillator 143 may be fed to a discharge reservoir or another combustor (in other words fuel nozzle or burner of another combustor) or fluid boundary layer represented by the reference numeral 152.

Referring to FIG. 7, a tunable fluid flow control system 154 is disclosed. In the illustrated embodiment, the system 154 is a closed-loop system. The control system 154 includes one or more fluidic oscillators 156 configured to provide a pulsed fuel stream to a combustor or a pulsed control jets to a fluid boundary layer. The combustor or the fluid boundary layer is represented by the reference numeral 158. In the illustrated embodiment, a portion of a fluid stream may be diverted through an amplitude control device 160 configured to control amplitude of the pulsating fluid stream generated from the fluidic oscillator 156. The control device 160 may be a mechanical valve or a fluidic switch. A frequency control device 162 is configured to control flow of gas fed to the fluidic oscillator 156. The control device 162 may include one or more mechanical valves or pressure regulators or fluidic switches. The system 154 includes at least one transducer (sensor) 164 configured to detect dynamic pressure variations in the combustor or drag of the fluid boundary layer. Additionally, the system 154 includes a controller 166 coupled to the transducer 164 and the control devices 160, 162. The controller 166 is configured to control the devices 160, 162 based on the transducer output so as to vary a cavity volume in order to control frequency, amplitude, or combinations thereof of flow of a pulsating fluid fed through the fluidic oscillator 156. In a closed-loop system, the pressure of the gas stream fed to the boundary wall is controlled automatically.

In the illustrated embodiment, the controller 166 may further include a database, an algorithm, and a data analysis block. The database may be configured to store predefined information about the system 154. For example, the database may store information relating to a system of interest such as a combustor, a system incorporating for example: fluid boundary layer; type of transducer; number of fluidic oscillators; type of boundary wall; fluid stream fed through the fluidic oscillator; pressurized gas source; or the like. The database may also include instruction sets, maps, lookup tables, variables, or the like. Such maps, lookup tables, instruction sets, are operative to correlate characteristics of the combustor or fluid boundary layer to pressure of the gas source, frequency, amplitude of pulsating fluid stream fed through the fluidic oscillator 156, or the like. Furthermore, the database may be configured to store actual sensed/detected information from the transducer 164. The algorithm facilitates the processing of signals from the transducer 164.

The data analysis block may include a variety of circuitry types, such as a microprocessor, a programmable logic controller, a logic module, etc. The data analysis block in combination with the algorithm may be used to perform the various computational operations relating to pressure of gas stream fed to the boundary wall of the fluidic oscillator, frequency, amplitude of pulsating fluid stream fed through the fluidic oscillator, pressure variations in combustor, fluid boundary layer drag, or a combination thereof. Any of the above mentioned parameters may be selectively and/or dynamically adapted or altered relative to time. One of the pulsating fluid stream from the fluidic oscillator 142 may be fed to a discharge reservoir, or another combustor (in other words fuel nozzle or burner of another combustor) or fluid boundary layer represented by the reference numeral 168.

In accordance with the embodiments discussed with reference to FIGS. 1-7, a tunable fluidic oscillator supplies a pulsating gas stream to s system of interest at a frequency that can be chosen by an operator or using a closed loop control system. A change in cavity volume may be accomplished via one or more diaphragms, one or more pistons, or one or more bellows. The exemplary tunable fluidic oscillator has much longer life than a mechanical valve. A range of jet frequencies can be created using the same fluidic oscillator, allowing the exemplary fluidic oscillator to respond to changing design or operating requirements.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A tunable fluid flow control system, comprising:
a fluidic oscillator comprising a movable boundary wall;
a pressurized gas source coupled to the movable boundary wall and configured to supply a stream of pressurized gas to the movable boundary wall to actuate the boundary wall;
wherein a portion of a fluid is bypassed the fluidic oscillator so as to control amplitude of flow of a pulsating fluid generated by the fluidic oscillator, or the boundary wall is actuatable to vary a cavity volume in the fluidic oscillator so as to control frequency of flow of the pulsating fluid generated by the fluidic oscillator, or combinations thereof.

2. The system of claim 1, wherein the movable boundary wall comprises at least one piston and cylinder, wherein the piston is actuatably disposed in the cylinder; wherein the piston is actuatable in response to the supply of the stream of the pressurized gas.

3. The system of claim 1, wherein the movable boundary wall comprises at least one bellow, wherein the bellow is actuatable in response to the supply of the stream of the pressurized gas.

4. The system of claim 1, wherein the movable boundary wall comprises at least one diaphragm, wherein the diaphragm is actuatable in response to the supply of the stream of the pressurized gas.

5. The system of claim 1, further comprising a frequency control device configured to control pressure of the gas fed to the fluidic oscillator.

6. The system of claim 5, wherein the frequency control device comprises a mechanical valve.

7. The system of claim 5, wherein the frequency control device comprises a fluidic switch.

8. The system of claim 5, wherein the frequency control device comprises a pressure regulator.

9. The system of claim 1, wherein the pulsating fluid comprises a fuel stream fed to a combustor, wherein frequency, amplitude, or combinations thereof of flow of fuel stream generated by the fluidic oscillator are controlled to control combustion dynamics within the combustor.

10. The system of claim 9, wherein one pulsating fuel stream from the fluidic oscillator is fed to a discharge reservoir or another combustor.

11. The system of claim 1, wherein frequency, amplitude, or combinations thereof of flow of the pulsating fluid generated by the fluidic oscillator are controlled for controlling drag of at least one fluid boundary layer.

12. The system of claim 1, further comprising an amplitude control device, wherein a portion of the fluid is fed through the amplitude control device bypassing the fluidic oscillator to control amplitude of the pulsating fluid generated by the fluidic oscillator.

13. A tunable fuel flow control system for controlling combustion in at least one combustor, comprising:
a fluidic oscillator comprising a movable boundary wall;
a pressurized gas source coupled to the movable boundary wall and configured to supply a stream of pressurized gas to the movable boundary wall to actuate the boundary wall;
a fuel nozzle or burner coupled to the fluidic oscillator and the at least one combustor; wherein the fluidic oscillator is configured to feed a pulsating fuel stream to the fuel nozzle or burner;
wherein a portion of a fuel is bypassed the fluidic oscillator so as to control amplitude of flow of a pulsating fuel generated by the fluidic oscillator, wherein the boundary wall is actuatable to vary a cavity volume in the fluidic oscillator so as to control frequency of flow of the pulsating fuel generated by the fluidic oscillator.

14. The system of claim 13, wherein the movable boundary wall comprises at least one piston and cylinder, wherein the piston is actuatably disposed in the cylinder; wherein the piston is actuatable in response to the supply of the stream of the pressurized gas.

15. The system of claim 13, wherein the movable boundary wall comprises at least one bellow, wherein the bellow is actuatable in response to the supply of the stream of the pressurized gas.

16. The system of claim 13, wherein the movable boundary wall comprises at least one diaphragm, wherein the diaphragm is actuatable in response to the supply of the stream of the pressurized gas.

17. The system of claim 13, further comprising a frequency control device configured to control the pressure of the gas fed to the fluidic oscillator.

18. The system of claim 17, wherein the frequency control device comprises a mechanical valve.

19. The system of claim 17, wherein the frequency control device comprises a fluidic switch.

20. The system of claim 17, wherein the frequency control device comprises a pressure regulator.

21. The system of claim 13, further comprising an amplitude control device, wherein a portion of the fuel stream is fed through the amplitude control device bypassing the fluidic oscillator to control amplitude of the pulsating fuel stream generated by the fluidic oscillator.

22. The system of claim 13, wherein one pulsating fuel stream from the fluidic oscillator is fed to a discharge reservoir or another combustor.

23. A tunable fluid flow control system, comprising:
a fluidic oscillator comprising a movable boundary wall;
a pressurized gas source coupled to the movable boundary wall and configured to supply a stream of pressurized gas to the movable boundary wall to actuate the boundary wall;
wherein a portion of a fluid is bypassed the fluidic oscillator so as to control amplitude of flow of a pulsating fluid generated by the fluidic oscillator to control drag of at least one fluid boundary layer, or the boundary wall is actuatable to vary a cavity volume in the fluidic oscillator so as to control frequency of flow of the pulsating fluid generated by the fluidic oscillator to control drag of at least one fluid boundary layer, or combinations thereof.

24. The system of claim 23, wherein the movable boundary wall comprises at least one piston and cylinder, wherein the piston is actuatably disposed in the cylinder; wherein the piston is actuatable in response to the supply of the stream of the pressurized gas.

25. The system of claim 23, wherein the movable boundary wall comprises at least one bellow, wherein the bellow is actuatable in response to the supply of the stream of the pressurized gas.

26. The system of claim 23, wherein the movable boundary wall comprises at least one diaphragm, wherein the diaphragm is actuatable in response to the supply of the stream of the pressurized gas.

27. The system of claim 23, further comprising a frequency control device configured to control pressure of the gas fed to the fluidic oscillator.

28. The system of claim 23, further comprising an amplitude control device, wherein a portion of the fluid stream is fed through the amplitude control device bypassing the fluidic oscillator to control amplitude of the pulsating fluid generated by the fluidic oscillator.

29. The system of claim 23, wherein one pulsating fluid stream from the fluidic oscillator is fed to a discharge reservoir or another fluid boundary layer.

30. An open-loop tunable fluid flow control system, comprising:
a sensor configured to detect dynamic pressure variations of at least one combustor, drag of at least one fluid boundary layer, or combinations thereof;
a fluidic oscillator comprising a movable boundary wall;
a pressurized gas source coupled to the movable boundary wall and configured to supply a stream of pressurized gas to the movable boundary wall to actuate the boundary wall;
wherein a portion of a fluid is bypassed the fluidic oscillator so as to control amplitude of flow of a pulsating fluid generated by the fluidic oscillator based on an amplitude set value, wherein the boundary wall is actuatable to vary a cavity volume in the fluidic oscillator so as to control frequency of flow of the pulsating fluid generated by the fluidic oscillator based on a frequency set value; wherein frequency, amplitude, or combinations thereof of flow of the pulsating fluid is controlled to control dynamic pressure variations of the at least one combustor, drag of the at least one fluid boundary layer, or combinations thereof.

31. The system of claim 30, wherein the movable boundary wall comprises at least one piston and cylinder, wherein the piston is actuatably disposed in the cylinder; wherein the piston is actuatable in response to the supply of the stream of the pressurized gas.

32. The system of claim 30, wherein the movable boundary wall comprises at least one bellow, wherein the bellow is actuatable in response to the supply of the stream of the pressurized gas.

33. The system of claim 30, wherein the movable boundary wall comprises at least one diaphragm, wherein the diaphragm is actuatable in response to the supply of the stream of the pressurized gas.

34. The system of claim 30, further comprising a frequency control device configured to control pressure of the gas fed to the fluidic oscillator.

35. The system of claim 30, further comprising an amplitude control device, wherein a portion of the fluid stream is fed through the amplitude control device bypassing the fluidic oscillator to control amplitude of the pulsating fluid generated by the fluidic oscillator.

36. The system of claim 30, wherein one pulsating fluid stream from the fluidic oscillator is fed to a discharge reservoir, or another combustor, or another fluid boundary layer.

37. A closed-loop tunable fluid flow control system, comprising:
a sensor configured to detect dynamic pressure variations of at least one combustor, drag of at least one fluid boundary layer, or combinations thereof;
a fluidic oscillator comprising a movable boundary wall;
a pressurized gas source coupled to the movable boundary wall and configured to supply a stream of pressurized gas to the movable boundary wall to actuate the boundary wall;
a controller coupled to the sensor, and the fluidic oscillator, wherein the controller is configured to control flow of a portion of a fluid bypassing the fluidic oscillator in response to a sensor output so as to control amplitude of flow of a pulsating fluid generated by the fluidic oscillator, wherein the controller is configured to control actuation of the boundary wall in response to the sensor output to vary a cavity volume in the fluidic oscillator so as to control frequency of flow of the pulsating fluid generated by the fluidic oscillator; wherein frequency, amplitude, or combinations thereof of flow of the pulsating fluid is controlled to control dynamic pressure variations of the at least one combustor, drag of the at least one fluid boundary layer, or combinations thereof.

38. The system of claim 37, wherein the movable boundary wall comprises at least one piston and cylinder, wherein the piston is actuatably disposed in the cylinder; wherein the piston is actuatable in response to the supply of the stream of the pressurized gas.

39. The system of claim 37, wherein the movable boundary wall comprises at least one bellow, wherein the bellow is actuatable in response to the supply of the stream of the pressurized gas.

40. The system of claim 37, wherein the movable boundary wall comprises at least one diaphragm, wherein the diaphragm is actuatable in response to the supply of the stream of the pressurized gas.

41. The system of claim 37, further comprising a frequency control device coupled to the controller; wherein the controller is adapted to control the frequency control device so as to control the frequency of flow of the pulsating fluid generated by the fluidic oscillator.

42. The system of claim 37, further comprising an amplitude control device coupled to the controller, wherein the controller is adapted to control the amplitude control device so as to control feeding of a portion of the fluid stream through the amplitude control device bypassing the fluidic oscillator to control amplitude of the pulsating fluid generated by the fluidic oscillator.

43. The system of claim 37, wherein one pulsating fluid stream from the fluidic oscillator is fed to a discharge reservoir, or another combustor, or another fluid boundary layer.
